(19) United States
(12) Patent Application Publication
(10) Pub. No.: US 2012/0301727 A1
(43) Pub. Date: Nov. 29, 2012

(54) FLOORING MATERIAL

(76) Inventors: Chul Hyun Kim, Chungcheongbuk-do (KR); Han Chul Jang, Gyeonggi-do (KR)

(21) Appl. No.: 13/576,881

(22) PCT Filed: Feb. 9, 2011
(86) PCT No.: PCT/KR11/00859

§ 371 Date: Aug. 2, 2012

(30) Foreign Application Priority Data
Feb. 16, 2010 (KR) 10-2010-0013792

(51) Int. Cl. B32B 27/20; B32B 21/08; B32B 27/08; B32B 5/30; B82Y 30/00

(52) U.S. Cl. 428/414; 428/524; 428/423.1; 428/522; 428/474.4; 428/688; 428/457; 428/523; 428/480; 428/521; 428/537.1; 977/779

(57) ABSTRACT

The present invention provides flooring material which comprises a thermal conductive base material with a resin film including a carbon nano-tube; or a thermal conductive sheet. The flooring material of the present invention has high floor heating efficiency because thermal conduction is high and can save energy.

### TECHNICAL FIELD

The present invention relates to a flooring material which comprises a thermal conductive base material with a resin film including a carbon nano-tube; or a thermal conductive sheet.

### BACKGROUND ART

Generally, a flooring material used in various buildings such as an apartment and a house includes plywood, a wood sheet layer formed on the plywood, and a surface protective layer formed on the wood sheet layer.

However, since the flooring material has a low thermal conductivity, heat is not quickly transferred from a heating pipe arrangement to the floor. Therefore, there is a problem that it takes a long time to warm up the entire floor. Further, in the conventional flooring material, it is not possible to uniformly maintain temperature of the floor due to thermal short phenomenon in which only a part of the floor around the heat pipe is warmed up, and thus excessive energy is needed upon heating.

### DISCLOSURE

### Technical Problem

An object of the present invention is to provide a flooring material.

### Technical Solution

To achieve the object of the present invention, the present invention provides a flooring material which comprises a thermal conductive base material with a resin film including a carbon nano-tube; or a thermal conductive sheet.

### Advantageous Effects

According to the present invention, it is possible to provide the flooring material which has the excellent heating efficiency due to the high thermal conductivity, thereby achieving the energy saving effect.

### DESCRIPTION OF DRAWINGS

FIG. 1 is a view of a thermal conductive base material according to one embodiment of the present invention.

FIG. 2 is a view of a thermal conductive base material according to another embodiment of the present invention.

FIG. 3 is a view of a thermal conductive base material with a reinforcing portion attached to both surfaces of a base portion through a resin film.

FIG. 4 is a view of a flooring material according to one embodiment of the present invention.

FIG. 5 is a view of a flooring material according to another embodiment of the present invention.

FIG. 6 is a view of a flooring material according to yet another embodiment of the present invention.

[Detailed Description of Main Elements]

| | |
|---|---|
| 100: thermal conductive base material | 110: base portion |
| 120a: first resin film | 120b: second resin film |
| 130a: first reinforcing portion | 130b: second reinforcing portion |
| 140: wood sheet layer | 150: surface protective layer |
| 160: thermal conductivity | 200: flooring material |

### BEST MODE

The present invention relates to a flooring material which comprises a thermal conductive base material with a resin film including a carbon nano-tube; or a thermal conductive sheet.

Hereinafter, the flooring material of the present invention will be described in detail with reference to accompanying drawings.

A flooring material of the present invention may include a thermal conductive base material, and the thermal conductive base material may have a resin film including a carbon nano-tube.

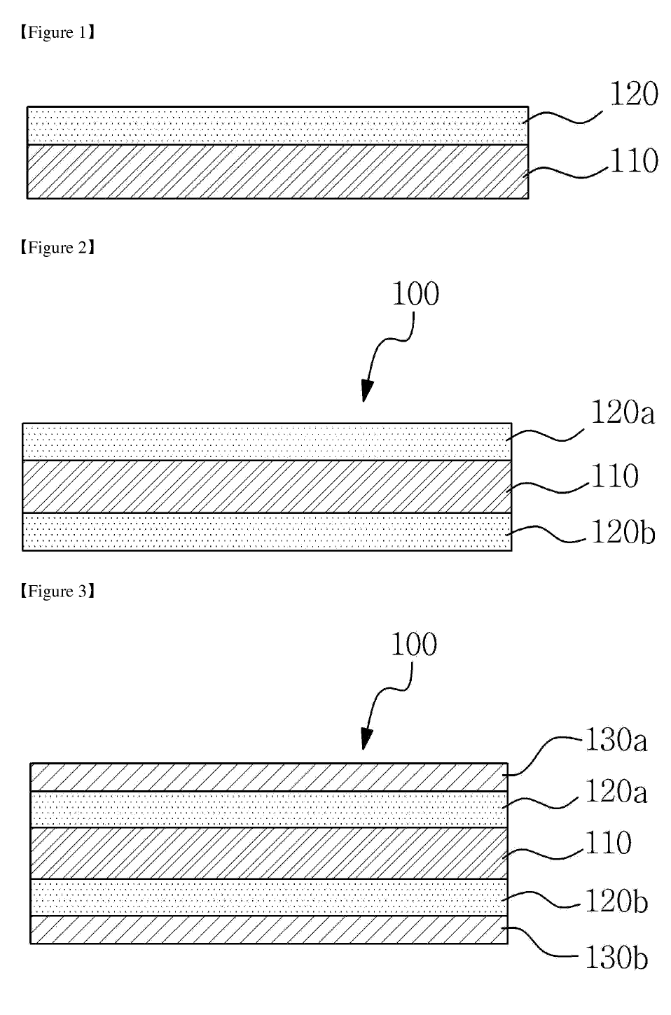

For example, as shown in FIGS. 1 and 2, a thermal conductive base material 100 of the present invention may include a base portion 110 and a resin film 120, 120a, 120b formed on one surface or both surfaces of the base portion 110.

The base portion may function to provide enough strength to the flooring material against external shock.

The kind of the base portion used in the present invention is not limited specially. For example, the base portion may be formed of a general wood material well known in the art. The wood material may include raw material lumber, single board, plywood, particle board, MDF (Medium Density Fiberboard), HDF (High Density Fiberboard), OSB (Oriented Strand Board), resin-wood flour mixed board, flake board and WPC (Wood Polymer Composite) and the like. Herein, it is preferable to use the single board, but the present invention is not limited to this.

In the present invention, a thickness of the base portion is not limited specially. For example, the base portion may have a thickness of 1.0˜10.0 mm. If the thickness of the base portion is less than 1.0 mm, the efficiency of forming the resin film may be lowered, and if the thickness of the base portion is more than 10.0 mm, the thermal conductivity may be reduced.

The resin film of the present invention is formed on one surface or both surfaces of the base portion.

The resin film may include a carbon nano-tube and a resin component, and the resin component may be an adhesive resin.

Because the carbon nano-tube has a very excellent thermal conductivity of 1800˜6000 Kcal/m·hr·° C., it can function to increase the heating efficiency of the flooring material.

Further, since the carbon nano-tube has excellent dispersibility, the carbon nano-tubes are not at a certain place, thereby achieving uniform thermal distribution without thermal concentration.

The kind of the carbon nano-tube used in the present invention is not limited specially. For example, the carbon nano-tube may include a single-walled carbon nano-tube, a double-walled carbon nano-tube, a multi-walled carbon nano-tube and the like. In the present invention, it is possible to use all kinds of carbon nano-tubes regardless of shapes, diameters and lengths thereof.

The kind of the resin component used in the present invention is not limited specially. For example, the resin component may be one or more selected from a group consisting of a thermosetting melamine resin, a phenol resin, a urea resin, a thermosetting epoxy resin, a cold-setting epoxy resin, a polyurethane resin, an acrylic resin, a polyvinyl acetate resin, a polyvinyl alcohol resin, and a polyamide resin.

The resin film of the present invention may contain 5˜20 parts by weight of the carbon nano-tube with respect to 100 parts by weight of the resin component. If the content of the carbon nano-tube is less than 5 parts by weight, the heating effect may be deteriorated, and if the content of the carbon nano-tube is more than 20 parts by weight, the dispersibility is lowered and a viscosity of the resin is increased, thereby deteriorating workability thereof.

The resin film of the present invention may further contain one or more thermal conductive materials selected from a group of aluminum, copper and iron.

An amount of the additional thermal conductive material included in the resin film may be 2˜5 parts by weight with respect to 100 parts by weight of the resin component. If the content thereof is less than 2 parts by weight, the effect of reinforcing the thermal conductivity may be deteriorated, and if the content thereof is more than 5 parts by weight, the adhesive of the rein film may be reduced.

If necessary, the resin film of the present invention may further include a filler, a diluent and a pigment.

In the present invention, a thickness of the resin film is not limited specially. For example, the resin film may have a thickness of 100˜200 μm. If the thickness of the resin film is less than 100 μm, the thermal conductivity or the adhesive may be lowered, and if the thickness of the resin film is more than 200 μm, the workability for forming the resin film may be reduced.

For example, as shown in FIG. 3, the thermal conductive base material 100 of the present invention may further include a reinforcing portion 130a, 130b which are attached to both surfaces of the base portion 110 via the resin film 120a, 120b. The kind of the reinforcing portion is not limited specially. For example, the reinforcing portion may be formed of the same material as the base portion, and may be preferably formed of the single board.

In the thermal conductive base material 100, the first resin film 120a is formed on the base portion 110, the first reinforcing portion 130a is formed on the first resin film 120a, the second resin film 120b is formed beneath the base portion 110, and the second reinforcing portion 130b is formed beneath the second resin film 120b.

A thickness of the reinforcing portion formed on both surfaces is not limited specially. For example, the reinforcing portion may have a thickness of 1.0˜2.0 mm. If the thickness of the reinforcing portion is less than 1.0 mm, the strength against the external shock may be lowered, and if the thickness of the reinforcing portion is more than 2.0 mm, the flooring material becomes thick and thus the thermal conductivity thereof may be deteriorated.

Further, the flooring material of the present invention may include a thermal conductive sheet.

Since the thermal conductive sheet has a high thermal conductivity, it is possible to achieve the excellent heating efficiency.

The kind of synthetic resin is not limited specially. For example, the synthetic resin may be one or more selected from a group consisting of PVC (Poly Vinyl Chloride), PE (Poly Ethylene), PP (Poly Propylene), PET (Poly Ethylene Terephthalate), PETG (Poly Ethylene Terephthalate Glycolmodified), HIPS (High Impact Polystyrene), ABS (Acrylonitrile Butadiene Styrene), PU (Poly Urethane), SBS (Styrene Butadiene Styrene block copolymer), SEBS (Styrene Ethylene Butadiene Styrene block copolymer), SPS (Syndiotactic Poly Sryrene), SEPS (Styrene Ethylene Butylene Styrene block copolymer) and PLA (Poly Latic Acid), and may be preferably PVC.

The thermal conductive sheet of the present invention may contain 35˜50 parts by weight of the synthetic resin with respect to the content of the carbon nano-tube. If the synthetic resin is less than 35 parts by weight, it is not economical, and if the synthetic resin is more than 50 parts by weight, it is difficult to mix materials, thereby deteriorating processability and surface state thereof.

The carbon nano-tube used in the thermal conductive sheet may be the same as the above-mentioned one.

The thermal conductive sheet of the present invention may contain 5˜20 parts by weight of the carbon nano-tube with respect to the content of the synthetic resin. If the content of the carbon nano-tube is less than 5 parts by weight, the heating effect may be reduced, and if the content of the carbon nano-tube is more than 20 parts by weight, the dispersibility is lowered, and also the viscosity of the resin is increased, thereby deteriorating the workability.

The thermal conductive sheet of the present invention may further contain an inorganic filler. The kind of the inorganic filler is not limited specially. For example, the inorganic filler may be calcium carbonate. An amount of the inorganic filler contained in the thermal conductive sheet may be 40˜55 parts by weight with respect to the content of the carbon nano-tube or the synthetic resin.

Further, the thermal conductive sheet of the present invention may further contain one or more thermal conductive materials selected from a group of aluminum, copper and iron.

An amount of the thermal conductive material contained in the thermal conductive sheet may be 2˜5 parts by weight with respect to the content of the carbon nano-tube or the synthetic resin. If the content of the thermal conductive material is less than 2 parts by weight, the effect of reinforcing the thermal conductivity may be reduced, and if the content thereof is more than 5 parts by weight, the workability may be deteriorated.

A thickness of the thermal conductive sheet is not limited specially. For example, the thermal conductive sheet may have a thickness of 1.0˜2.0 mm. If the thickness of the thermal conductive sheet is less than 1.0 mm, a height difference between products may be occurred due to thickness variation in the manufacturing process, and if the thickness thereof is more than 2.0 mm, the manufacturing cost is increased and thus it is not economical.

The flooring material may further include a wood sheet layer formed on the thermal conductive base material, or the thermal conductive sheet.

In the present invention, the words “B formed on A” comprehensively means a case that A is directly attached on or beneath B, a case that a separate layer is formed on or beneath B and then A is directly attached on the separate layer or indirectly attached thereon via an adhesive or a sticking agent, and the like.

The wood sheet layer creates the natural texture of raw material lumber, thereby providing beautiful appearance of the flooring material.

The kind of the wood sheet layer is not limited specially. For example, the wood sheet layer may include patterns of various trees such as an oak tree, a birch tree, a cherry tree, a maple tree and a walnut tree.

According to the present invention, in order to improve water resistance and hardness of the product, a resin composite may be impregnated in the wood sheet layer. Herein, the kind of the resin composite is not limited specially, if it can improve the water resistance and hardness. For example, the resin composite may be one or more selected from a group of a urea resin, a urea-melamine resin, a melamine resin, a phenol resin, an acrylic resin, a polyester resin, an unsaturated polyester resin, an epoxy resin, a polyvinyl acetate resin and a urethane resin.

An amount of the resin composite impregnated in the wood sheet layer may be 30˜150 parts by weight with respect to 100 parts by weight of the wood sheet layer.

The impregnating of the resin composite in the wood sheet layer may be carried out by immersion, decompression, injection, or the like. After the resin composite is impregnated in the wood sheet layer, the wood sheet layer is treated for 20 seconds to 4 hours at an oven temperature of 80˜150° C. so that the resin composite can be dried, semi-hardened or hardened.

A thickness of the wood sheet layer is not limited specially. For example, the wood sheet layer may have a thickness of 0.3˜1.0 mm. If the thickness of the wood sheet layer is less than 0.3 mm, the deformation of the wood sheet layer, such as crack and distortion, may be occurred upon a drying process after the impregnating, and if the thickness thereof is more than 1.0 mm, the resin composite may be not impregnated completely in the wood sheet layer.

The wood sheet layer is attached on the thermal conductive base material or the thermal conductive sheet via the adhesive. The kind of the adhesive is not limited specially, and any adhesive known in the art can be used. According to the present invention, in order to increase the heating efficiency of the flooring material, the adhesive may further contain one or more thermal conductive materials selected from a group of carbon nano-tube, aluminum and copper.

Further, the flooring material of the present invention may further include a surface protective layer formed on the wood sheet layer.

The surface protective layer functions to protect a surface of the wood sheet layer and prevent dirt. And the surface protective layer is formed to be transparent so that the pattern of the wood sheet layer can be observed from the outside. Also, the surface protective layer functions to prevent damage to the surface of the wood sheet layer due to a sharp object, to provide excellent mechanical properties and to absorb the external shock.

If it is possible to provide the excellent mechanical properties and the transparency and absorb the external shock, the kind of the surface protective layer is not limited specially. For example, the surface protective layer may be formed of one or more transparent synthetic resins selected from a group of an epoxy resin, a fluorine resin, a urea resin, an acrylate resin and a polyester resin.

A thickness of the surface protective layer is not limited specially. For example, the surface protective layer may have a thickness of 80˜200 μm. If the thickness of the surface protective layer is less than 80 μm, the effect of protecting the wood sheet layer may be reduced, and if the thickness thereof is more than 200 μm, it is not economical, because the mechanical properties are not improved any longer.

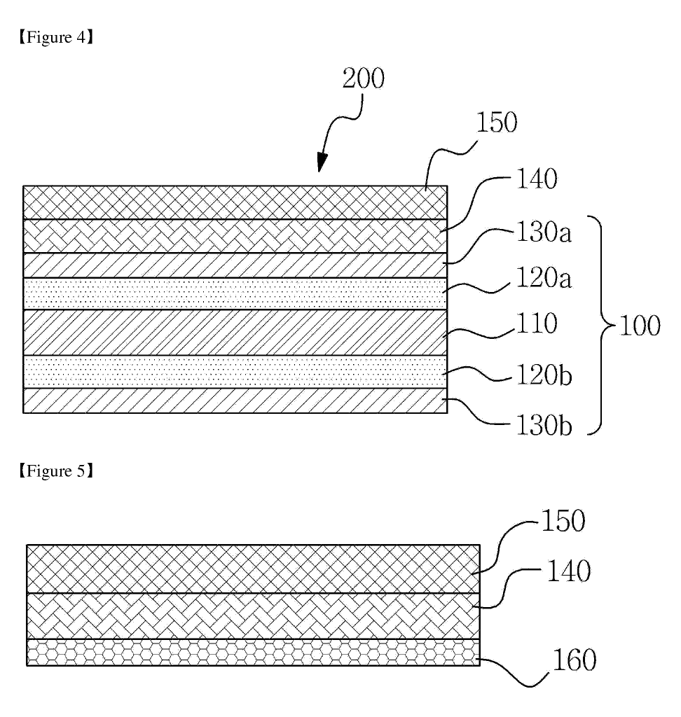

The flooring material of the present invention may have various configurations including the thermal conductive base material and the thermal conductive sheet. For example, the flooring material may have the configuration as shown in FIG. 4, 5 or 6.

FIG. 4 shows an example of a flooring material 200 according to the present invention. The flooring material includes a thermal conductive base material 100; a wood sheet layer 140 formed on the thermal conductive base material 100; and a surface protective layer 150 formed on the wood sheet layer 140.

Herein, the thermal conductive base material, the wood sheet layer and the surface protective layer are the same as the previously mentioned ones.

FIG. 5 shows another example of the flooring material 200 according to the present invention. The flooring material 200 includes a thermal conductive sheet 160; a wood sheet layer 140 formed on the thermal conductive sheet 160; and a surface protective layer 150 formed on the wood sheet layer 140.

Herein, the thermal conductive sheet, the wood sheet layer and the surface protective layer are the same as the previously mentioned ones.

The flooring material may further include a second base material (not shown) formed on the thermal conductive sheet. The kind of the second base material is not limited specially. For example, the second base material may be formed of the same materials as the base portion, and preferably formed of plywood.

Preferably, the second base material is attached on the thermal conductive sheet via an adhesive. Herein, any adhesive known in the art can be used.

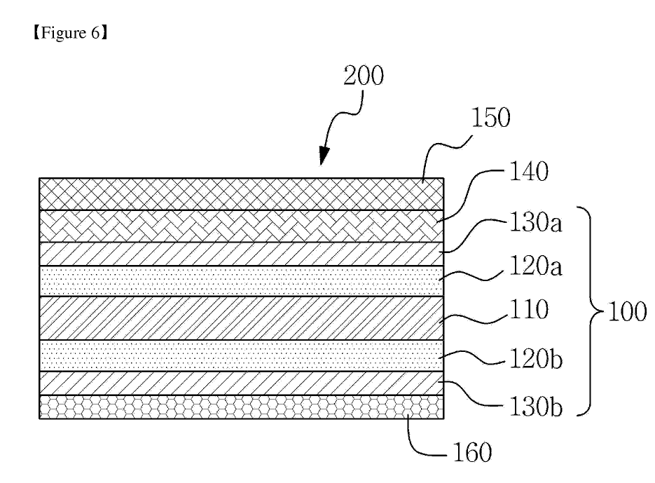

FIG. 6 shows yet another example of the flooring material 200 according to the present invention. Herein, since the flooring material 200 includes a thermal conductive base material 100 and a thermal conductive sheet 160, it is possible to achieve the more excellent thermal conductivity.

The flooring material 200 includes the thermal conductive sheet 160; the thermal conductive base material 100 formed on the thermal conductive sheet 160; a wood sheet layer 140 formed on the thermal conductive base material 100; and a surface protective layer 150 formed on the wood sheet layer 140.

Herein, the thermal conductive sheet, the thermal conductive base material, the wood sheet layer and the surface protective layer are the same as the previously mentioned ones.

The thermal conductive base material may be directly attached on the thermal conductive sheet via an adhesive. The kind of the adhesive is not limited specially, and any adhesive known in the art can be used. According to the present invention, in order to increase the heating efficiency of the flooring material, the adhesive may further contain one or more thermal conductive materials selected from a group of carbon nano-tube, aluminum and copper.

A method of manufacturing the thermal conductive base material or the thermal conductive sheet is not limited specially. For example, the thermal conductive base material or the thermal conductive sheet may be manufactured by the following method.

In the method of manufacturing the thermal conductive base material, a resin film is formed by coating a resin composite including a carbon nano-tube and a resin component on both surfaces of a base portion, and a reinforcing portion is formed on the both surfaces of the base portion via the resin film, and then a thermosetting or cold-setting process is performed by a press.

The resin component and the carbon nano-tube may be the same as the previously mentioned ones. Further, the resin composite may be prepared by, for example, dissolving or dispersing the resin component and the carbon nano-tube in a proper solvent. Herein, any solvent known in the art can be used.

The resin composite may further contain one or more thermal conductive materials selected from a group of aluminum, copper and iron. A method of coating the resin composite on the both surfaces of the base portion is not limited specially, and any method known in the art can be used.

A method of forming the reinforcing portion on the both surfaces of the base portion via the resin film is not limited specially, and any method known in the art can be used. In the present invention, the reinforcing portions facing with the base portion may be stacked so that fibers of the reinforcing portions are orthogonal to or parallel with each other, or so that each fiber direction of the reinforcing portions is different from each other with the base portion in the center.

The adhesion and hardening of the reinforcing portion formed on the both surfaces of the base portion via the resin film may be performed in a press. In case that the resin component of the resin film is a thermosetting type, the reinforcing portion can be hardened by thermo-compressing it for 5˜10 minutes at a temperature of 110˜130° C. and a pressure of 8˜15 kg/cm², and in case that the resin component of the resin film is a cold-setting type, the reinforcing portion can be hardened by thermo-compressing it for 30˜60 minutes at a pressure of 8˜15 kg/cm².

In the present invention, a method of manufacturing the thermal conductive sheet is not limited specially. For example, the thermal conductive sheet may be manufactured by casting, calendaring, extruding or pressing, and preferably manufactured by the calendaring.

A method of the manufacturing the flooring material is not limited specially. That is, the flooring material may be manufactured by various methods according to its structure.

Generally, the flooring material may be manufactured by forming the wood sheet layer and the surface protective layer on the thermal conductive sheet or the thermal conductive base material.

Particularly, the manufacturing method shown in FIG. 6 is not limited specially. For example, the flooring material may be manufactured by forming the wood sheet layer on the thermal conductive base material, forming the thermal conductive sheet beneath the thermal conductive base material and then forming the surface protective layer on the wood sheet layer.

Herein, the thermal conductive sheet is attached beneath the thermal conductive base material via an adhesive, and the wood sheet layer is attached on the thermal conductive base material via the adhesive so as to be orthogonal to the fiber direction.

### EMBODIMENT

Hereinafter, the embodiments of the present invention will be described in detail with reference to accompanying drawings. However, the present invention is not limited to the embodiment of the present invention.

### First Embodiment

### 1. Preparing of Thermal Conductive Base Material

A thermal conductive base material is prepared by coating a resin composite including 100 parts by weight of a thermosetting melamine resin and 10 parts by weight of a carbon nano-tube on both surfaces of a single board (a base portion) in a thickness of 120 μm so as to form a resin film and then sticking a single board (a reinforcing portion) having a thickness of 1.5 mm on the both surfaces of the base portion so that a fiber direction thereof is orthogonal to that of the signal board (the base portion). The prepared thermal conductive base material is thermo-compressed for 6 minutes at a temperature of 130° C. and a pressure of 10 kg/cm² in a press.

### 2. Preparing of Thermal Conductive Sheet

A thermal conductive sheet is prepared by sufficiently mixing 45 parts by weight of PVC, 45 parts by weight of calcium carbonate and 10 parts by weight of carbon nano-tube at 160° C. using a rolling roll

### 3. Manufacturing of Flooring Material

A polyvinyl acetate adhesive is coated on the thermal conductive base material in a thickness of 100 μm, and a wood sheet layer having 0.5 mm is stacked on the adhesive so that a fiber direction thereof is orthogonal to that of the signal board (the base portion). And then, the thermo-compressing is formed for 2 minutes at 120° C. and 10 kg/cm² in a press so as to form a half-finished product. When a surface temperature of the half-finished product reaches a room temperature, the polyvinyl acetate adhesive is coated beneath the thermal conductive base material in a thickness of 150 μm, and the thermal conductive sheet having a thickness of 2.0 mm are stacked. The half-finished product on which the thermal conductive sheet is stacked is compressed for 1 hour at a room temperature and a pressure of 10 kg/cm² in the press, and a surface protective layer having a thickness of 100 μm is formed on the wood sheet layer, and then a slitting process is carried out in the form of tongue's grooves, thereby manufacturing the flooring material.

### First Comparative Example

A flooring material was manufactured by the same method as in the first embodiment, except that water resistant plywood having a thickness of 7.0 mm is used instead of the thermal conductive base material and the thermal conductive sheet.

The flooring materials manufactured by the first embodiment and the first comparative example were compared with each other, and a result thereof is shown in Table 1.

In comparison of the thermal conductivity, heating at 50° C. was applied to the lower side of each flooring material, and then a surface temperature and a heat loss rate of each flooring material was measured and compared after 10 minutes when the surface temperature was not changed any longer

TABLE 1

| | Surface temperature (° C. ) | Heat loss |
|---|---|---|
| | of flooring material | rate (%) |
| First embodiment | 42.6 | 14.8 |
| First comparative example | 38.6 | 22.8 |

As shown in Table 1, after 10 minutes, the surface temperature of the flooring material in the first embodiment was higher than that of the first comparative example by 4° C. It could be also understood that the heat loss rate in the first embodiment was more excellent than that in the first comparative example.

### INDUSTRIAL APPLICABILITY

That is, since the flooring material of the present invention can improve the thermal conductivity, it is possible to provide the excellent heating efficiency and save energy.

While the present invention has been described with respect to the specific embodiments, it will be apparent to those skilled in the art that various changes and modifications may be made without departing from the spirit and scope of the invention as defined in the following claims.

1. A flooring material, comprising:
a thermal conductive base material with a resin film containing a carbon nano-tube; or
a thermal conductive sheet.

2. The flooring material according to claim 1, wherein the thermal conductive base material comprises a base portion, and a resin film which is formed at one surface or both surfaces of the base portion and which contains a resin component and a carbon nano-tube.

3. The flooring material according to claim 2, wherein the base portion is a single board.

4. The flooring material according to claim 2, wherein the resin component is a thermosetting melamine resin, a phenol resin, a urea resin, a thermosetting epoxy resin, a cold-setting epoxy resin, a polyurethane resin, an acrylic resin, a polyvinyl acetate resin, a polyvinyl alcohol resin, or a polyamide resin.

5. The flooring material according to claim 2, wherein the resin film contains 5˜20 parts by weight of the carbon nano-tube with respect to 100 parts by weight of the resin component.

6. The flooring material according to claim 2, wherein the resin film further contains aluminum, copper and iron

7. The flooring material according to claim 2, wherein the thermal conductive base material further comprises a reinforcing portion attached on both surfaces of the base portion via the resin film.

8. The flooring material according to claim 1, wherein the thermal conductive sheet contains a synthetic resin and a carbon nano-tube.

9. The flooring material according to claim 8, wherein the synthetic resin comprises one or more selected from a group of PVC (Poly Vinyl Chloride), PE (Poly Ethylene), PP (Poly Propylene), PET (Poly Ethylene Terephthalate), PETG (Poly Ethylene Terephthalate Glycolmodified), HIPS (High Impact Polystyrene), ABS (Acrylonitrile Butadiene Styrene), PU (Poly Urethane), SBS (Styrene Butadiene Styrene block copolymer), SEBS (Styrene Ethylene Butadiene Styrene block copolymer), SPS (Syndiotactic Poly Sryrene), SEPS (Styrene Ethylene Butylene Styrene block copolymer) and PLA (Poly Latic Acid)

10. The flooring material according to claim 9, wherein the thermal conductive sheet contains 35˜50 parts by weight of the synthetic resin with respect to the content of the carbon nano-tube.

11. The flooring material according to claim 8, wherein the thermal conductive sheet contains 5˜20 parts by weight of the carbon nano-tube with respect to the content of the synthetic resin.

12. The flooring material according to claim 8, wherein the thermal conductive sheet further contains aluminum, copper and iron.

13. The flooring material according to claim 1, wherein the flooring material comprises the thermal conductive base material; and the thermal conductive sheet formed beneath the thermal conductive base material.

14. The flooring material according to claim 13, further comprising a wood sheet layer formed on the thermal conductive base material.

15. The flooring material according to claim 14, further comprising a surface protective layer formed on the wood sheet layer.
